(19) United States
(12) Patent Application Publication
(10) Pub. No.: US 2013/0280627 A1
(43) Pub. Date: Oct. 24, 2013

(54) HYDROGEN-PURIFYING DEVICE

(71) Applicants: Po-Kuei Chou, Hsinchu County (TW); Tsai-Hsin Cheng, Hsinchu County (TW); Din-Sun Ju, Hsinchu County (TW); Wan-Lin Chen, Hsinchu County (TW)

(72) Inventors: Po-Kuei Chou, Hsinchu County (TW); Tsai-Hsin Cheng, Hsinchu County (TW); Din-Sun Ju, Hsinchu County (TW); Wan-Lin Chen, Hsinchu County (TW)

(73) Assignee: YOUNG GREEN ENERGY CO., Hsinchu County (TW)

(21) Appl. No.: 13/862,491

(22) Filed: Apr. 15, 2013

(30) Foreign Application Priority Data
Apr. 18, 2012 (CN) 201210113962.9

(51) Int. Cl. H01M 8/06

(52) U.S. Cl. CPC H01M 8/0662
USPC 429/411

(57) ABSTRACT

A hydrogen-purifying device is suitable for a fuel cell (FC). The hydrogen-purifying device includes a guiding tank, a first water-absorbing material, a porous filter material and a second water-absorbing material. The guiding tank is connected to a hydrogen-generating device and a fuel cell. The hydrogen-generating device generates hydrogen, moisture mixed with the hydrogen and impurities mixed with the hydrogen. The first water-absorbing material, the porous filter material and the second water-absorbing material are disposed in the guiding tank. The hydrogen passes through the first water-absorbing material to remove a part of the moisture. Then, the hydrogen further passes through the porous filter material to remove the impurity. After that, the hydrogen further passes through the second water-absorbing material to remove another part of the moisture and arrives at the fuel cell.

### CROSS-REFERENCE TO RELATED APPLICATION

This application claims the priority benefit of China application serial no. 201210113962.9, filed on Apr. 18, 2012. The entirety of the above-mentioned patent application is hereby incorporated by reference herein and made a part of this specification.

### BACKGROUND OF THE INVENTION

1. Field of the Invention

The invention generally relates to a gas-purifying device, and more particularly, to a hydrogen-purifying device.

2. Description of Related Art

The fuel cell (FC) is an electrical generating device by converting chemical energy into electrical energy. In comparison with the conventional electrical generating method, the fuel cell has advantages of low pollution, low noise, high energy density, and higher energy conversion efficiency and is a clean energy with the great future prospect. The applicable applications of the fuel cell include portable electronic products, home electrical generating systems, transportation means, military equipments, space industry, small electrical generating systems, and so on.

Based on the different operation principles and operation environments, various fuel cells have different application fields. In terms of the movable energy application, the major fuel cells are proton exchange membrane fuel cell (PEMFC) and direct methanol fuel cell (DMFC), both of which belong to low-temperature-starting fuel cells by using proton exchange membrane to conduct proton conducting mechanism. This kind of proton exchange membrane FC is based on the operation principle that conducting oxidation reaction by hydrogen at the anode catalyst layer to generate hydrogen ions (H+) and electrons (e−) (PEMFC principle) or conducting oxidation reaction by methanol and water at the anode catalyst layer to generate hydrogen ions (H+), CO₂ and electrons (e−) (DMFC principle), in which the hydrogen ions (H+) migrate to the cathode through the proton exchange membrane, while the electrons (e−) are transmitted to a load through an external circuit and then is transmitted to the cathode after doing work. At the time, the oxygen provided to the cathode terminal would conduct reduction reaction with the hydrogen ions (H+) and the electrons (e−) at the cathode catalyst layer to generate water.

It is a common hydrogen-generating method of a fuel cell by means of the reaction between a solid fuel and water to generate hydrogen. However, the reaction between the solid fuel and water is an exothermic reaction which will produce large amounts of moisture. In addition, during the process, the solid fuel itself has chance to contact impurities, and in turn, the impurities may be transmitted into the fuel cell through gas produced from the reaction as a carrier. The impurities are, for example, hydrogen sulfide (H₂S), ammonia (NH₃) or carbon monoxide (CO), and the impurities may result in permanent damage of the fuel cell and shorten the lifetime of the cell stack.

US Patent publication No. 20080113249 discloses a fuel cell system by using a filter device to remove impurities in the fuel. US Patent publication No. 20070077482 discloses a fuel cell system, wherein an air filter is disposed at the outlet of a fuel cartridge for removing harmful substance. US Patent publication No. 20090301308 discloses a filter device for filtering the air of the fuel cell. Taiwan Patent No. 1319638 discloses a fuel supply, which includes a fuel container and an impurities-removing cartridge. Taiwan Patent No. 1337888 discloses a granular adsorbent material and a fibrous adsorbent material for absorbing molecular contaminants in gas state. Taiwan Patent No. M377996 discloses a thermoplastic non-woven fabric sheet, which includes a waterproof non-woven fabric layer, a skin-friendly non-woven fabric layer, and a filter non-woven fabric layer. Taiwan Patent No. M394145 discloses a filter material, which includes a non-woven fabric at its outer layer and an activated carbon at its inner layer. Taiwan Patent No. 1326723 discloses a filter which uses a woven fabric formed by carbon fibers or a non-woven fabric to remove impurities. Taiwan Patent publication No. 200816552 discloses a cell unit which uses a filter layer made of porous material to filter out impurities from the external air.

### SUMMARY OF THE INVENTION

Accordingly, the invention is directed to a hydrogen-purifying device able to effectively filter out impurities mixed with the hydrogen.

Other objectives and advantages of the invention should be further indicated by the disclosures of the invention, and omitted herein for simplicity.

To achieve one of, a part of or all of the above-mentioned objectives, or to achieve other objectives, an embodiment of the invention provides a hydrogen-purifying device suitable for a fuel cell (hereafter, FC). The hydrogen-purifying device includes a guiding tank, a first water-absorbing material, a porous filter material, and a second water-absorbing material. The guiding tank has a first end and a second end opposite to the first end, wherein the first end is connected to a hydrogen-generating device, the second end is connected to the fuel cell, and the hydrogen-generating device generates a hydrogen, a moisture mixed with the hydrogen, and an impurity mixed with the hydrogen. The first water-absorbing material is disposed in the guiding tank. The hydrogen passes through the first water-absorbing material to remove at least a part of the moisture. The porous filter material is disposed in the guiding tank and between the first water-absorbing material and the second end. After the hydrogen passes through the first water-absorbing material, the hydrogen passes through the porous filter material to remove the impurity mixed with the hydrogen. The second water-absorbing material is disposed in the guiding tank and between the porous filter material and the second end. After the hydrogen passes through the porous filter material, the hydrogen passes through the second water-absorbing material to remove another part of the moisture and arrives at the fuel cell.

Based on the description above, in the above-mentioned embodiment of the invention, the hydrogen-purifying device uses the porous filter material to filter out the impurities mixed with the hydrogen to avoid the impurities from following the hydrogen to arrive at the fuel cell and result in a negative effect on the fuel cell. In addition, prior to the hydrogen passes through the porous filter material, the hydrogen passes through the first water-absorbing material to remove at least a part of the moisture mixed with the hydrogen, which reduces the destruction on the porous filter material by the acid substance in the moisture to ensure the good filtering effect on the porous filter material. Moreover, after the hydrogen passes through the porous filter material, the hydrogen further passes through the second water-absorbing material to further remove the rest moisture and avoid excessive moisture from entering the fuel cell to affect the normal operation.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram of a hydrogen-purifying device according to an embodiment of the invention.

FIG. 2 is a partial diagram of the first water-absorbing material of FIG. 1.

FIG. 3 is a partial diagram of the porous filter material of FIG. 1.

FIG. 4 is a schematic diagram of a hydrogen-purifying device according to another embodiment of the invention.

FIG. 5 is a schematic diagram of a hydrogen-purifying device according to yet another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

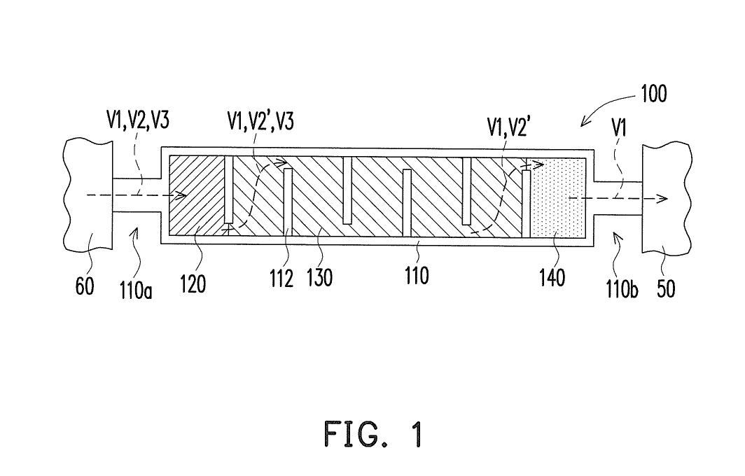

FIG. 1 is a schematic diagram of a hydrogen-purifying device according to an embodiment of the invention. Referring to FIG. 1, the hydrogen-purifying device 100 of the embodiment is for a fuel cell 50 and includes a guiding tank 110, a first water-absorbing material 120, a porous filter material 130, and a second water-absorbing material 140. The guiding tank 110 has a first end 110a and a second end 110b opposite to the first end 110a. The first end 110a is connected to a hydrogen-generating device 60 and the second end 110b is connected to the fuel cell 50. The hydrogen-generating device 60 generates hydrogen V1 through a reaction of a solid fuel and water, in which the reaction is an exothermic reaction and could produce moisture V2 mixed with the hydrogen V1. In addition, during the process, the solid fuel could contact impurities V3, and the impurities V3 are mixed with the hydrogen V1. The impurities V3 are, for example, ammonia (NH₃), hydrogen sulfide (H₂S) or carbon monoxide (CO).

The first water-absorbing material 120 is disposed in the guiding tank 110, the porous filter material 130 is disposed in the guiding tank 110 and between the first water-absorbing material 120 and the second end 110b, and the second water-absorbing material 140 is disposed in the guiding tank 110 and between the porous filter material 130 and the second end 110b. The hydrogen V1 passes through the first water-absorbing material 120 to remove at least a part of the moisture V2 mixed with the hydrogen V1. Then, the hydrogen V1, the rest moisture V2′, and the impurities V3 pass through the porous filter material 130 to remove the impurities V3 mixed with the hydrogen V1 through the filtering of the porous filter material 130. After the hydrogen V1 passes through the porous filter material 130, the hydrogen V1 would pass through the second water-absorbing material 140 to remove the rest moisture V2′ mixed with the hydrogen V1. Finally, the hydrogen V1 arrives at the fuel cell 50 for reaction.

Under the above-mentioned configuration, the hydrogen-purifying device 100 uses the porous filter material 130 to remove the impurities V3 mixed with the hydrogen V1 so as to avoid the impurities V3 accompanying the hydrogen V1 to arrive at the fuel cell 50 and result in a negative effect on the fuel cell 50. In addition, prior to the hydrogen V1 passes through the porous filter material 130, the hydrogen V1 passes through the first water-absorbing material 120 to remove at least a part of the moisture V2 mixed with the hydrogen V1, which reduces the destruction on the porous filter material 130 by the acid substance in the moisture V2 to ensure the good filtering effect on the porous filter material 130. Moreover, after the hydrogen V1 passes through the porous filter material 130, the hydrogen V1 further passes through the second water-absorbing material 140 to further remove the rest moisture V2′ and avoid excessive moisture entering the fuel cell 50 to affect the normal operation.

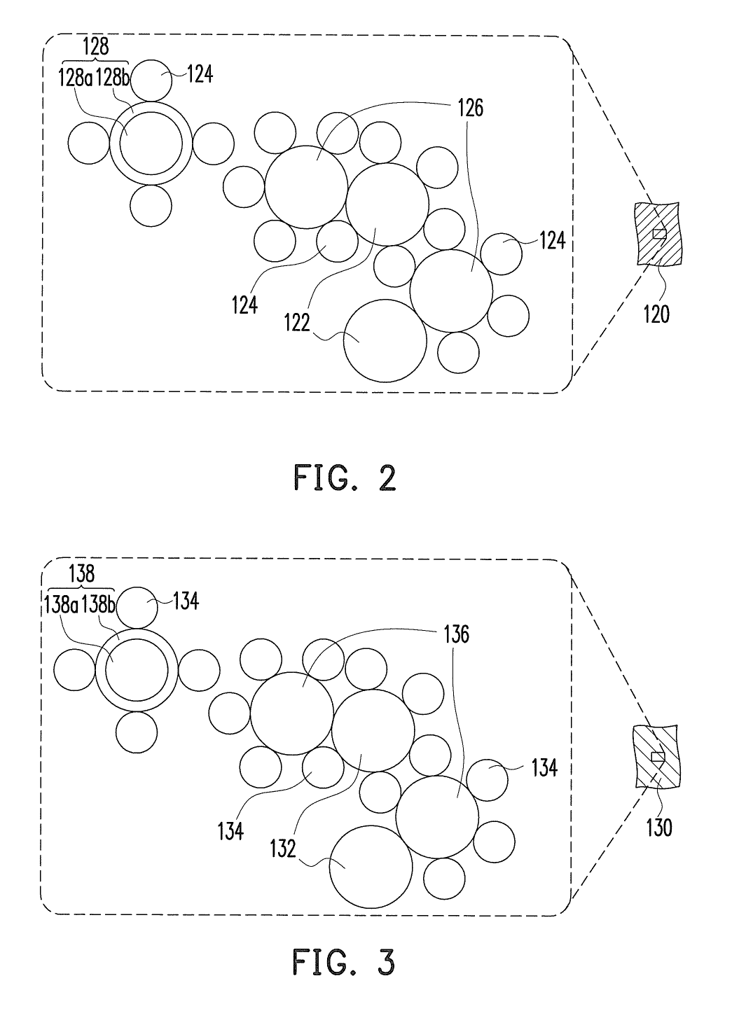

FIG. 2 is a partial diagram of the first water-absorbing material of FIG. 1. Referring to FIGS. 1 and 2, in the embodiment, the first water-absorbing material 120, for example, is a non-woven fabric structure and includes a plurality of non-woven fibers 122 and a plurality of water-absorbing particles 124. At least a part of the water-absorbing particles 124 are fused to these non-woven fibers 122. In more details, the above-mentioned non-woven fabric structure further includes a plurality of hot-melt powder particles 126, and these hot-melt powder particles 126 are combined with these non-woven fibers 122 in a fusion process or other ways (for example, carrying). The water-absorbing particles 124 are also combined with these hot-melt powder particles 126 in fusion process or other ways (for example, carrying). The material of the water-absorbing particles 124 of the first water-absorbing material 120 includes, for example, calcium chloride (CaCl₂), calcium oxide (CaO), silica gel, iron powder, sodium chloride (NaCl), zeolite, activated carbon, phosphorus pentoxide, poly sodium acrylate, cane fibers, sodium borohydride (NaBH₄), porous acidic water-absorbing material, psyllium flour, acidic polymer, alkaline polymer, cobalt chloride (CoCl₂) or other appropriate materials.

In the embodiment, the materials of the non-woven fibers 122 and the hot-melt powder particles 126 could be plastic, and the melting point of the non-woven fibers 122 is higher than the melting point of the hot-melt powder particles 126. When the non-woven fibers 122, the hot-melt powder particles 126, and the water-absorbing particles 124 are combined with each other in a fusion process, the heating temperature ranges between the melting point of the non-woven fibers 122 and the melting point of the hot-melt powder particles 126, so as to make the hot-melt powder particles 126 heated and fused to combine with the non-woven fibers 122 and the water-absorbing particles 124. At the time, due to a higher melting point, the non-woven fibers 122 is not melted so as to be able support the whole structure. Taking an example, the material of the non-woven fibers 122 could be polypropylene (PP) with an approximate melting point of 180° C., while the material of the hot melt powder particles 126 could be polyethylene (PE) with an approximate melting point of 127° C. The material of the non-woven fibers 122 could also be PVC (poly vinyl chloride), polystyrene (PS), polyethylene or rayon fibers, which the invention is not limited to. In addition, the percentage by weight of the water-absorbing particles 124 in the whole structure is, for example, 5%-30% to obtain a better water-absorbing capability and a strong structure strength. In other embodiments, the percentage by weight of the water-absorbing particles 124 in the whole structure could be other appropriate values depending on the requirement.

As shown by FIG. 2, it is allowed to mix a plurality of core-sheath fibers 128 with the non-woven fibers 122 (one core-sheath fiber 128 is shown). Each of the core-sheath fibers 128 includes a core layer 128a and a sheath layer 128b, and the sheath layer 128b wraps the core layer 128a. A part of the water-absorbing particles 124 are combined with the sheath layer 128b to form a structure with the non-woven fibers 122 and the core-sheath fibers 128. In the embodiment, the materials of the core layer 128a and the sheath layer 128b are, for example, plastic, the melting point of the non-woven fibers 122 is higher than the melting point of the sheath layer 128b, and the melting point of the core layer 128a is higher than the melting point of the sheath layer 128b. During the process of combining the non-woven fibers 122, the hot-melt powder particles 126, and the water-absorbing particles 124 together, the heating temperature range between the melting point of the non-woven fibers 122 and the melting point of the hot-melt powder particles 126 and between the melting point of the core layer 128a and the melting point of the sheath layer 128b so as to make the sheath layer 128b heated and fused to combine with the water-absorbing particles 124. At the time, due to the core layer 128a with a higher melting point, the core layer 128a is not melted so as to be able support the whole structure. Taking an example, the material of the core layer 128a could be polypropylene (PP) with melting point of about 180° C., while the material of the sheath layer 128b could be polyethylene (PE) with an approximate melting point of 127° C.

FIG. 3 is a partial diagram of the porous filter material 130 of FIG. 1. Referring to FIGS. 1 and 3, in the embodiment, the porous filter material 130, for example, includes a plurality of non-woven fibers 132 and a plurality of impurity-absorbing particles 134. At least a part of the impurity-absorbing particles 134 are fused to these non-woven fibers 132. In more details, the above-mentioned non-woven fabric structure further includes a plurality of hot-melt powder particles 136, and these hot-melt powder particles 136 are fused to these non-woven fibers 132. At least a part of the impurity-absorbing particles 134 are also fused to these hot-melt powder particles 136. The material of the impurity-absorbing particles 134 of the porous filter material 130 is, for example, activated carbon, zeolite, solid acid, acidic polymer, alkaline polymer or other suitable materials, which the invention is not limited to.

In the embodiment, the materials of the non-woven fibers 132 and the hot-melt powder particles 136 are, for example, plastic, and the melting point of the non-woven fibers 132 is higher than the melting point of the hot-melt powder particles 136. When the non-woven fibers 132, the hot-melt powder particles 136, and the impurity-absorbing particles 134 are combined with each other in a fusion process, the heating temperature ranges between the melting point of the non-woven fibers 132 and the melting point of the hot-melt powder particles 136, so as to make the hot-melt powder particles 136 heated and fused to combine with the non-woven fibers 132 and the impurity-absorbing particles 134. At the time, due to the non-woven fibers 132 with a higher melting point, the non-woven fibers 132 is not melted so as to be able support the whole structure. Taking an example, the material of the non-woven fibers 132 could be polypropylene (PP) with an approximate melting point of 180° C., while the material of the hot melt powder particles 136 could be polyethylene (PE) with an approximate melting point of 127° C. The material of the non-woven fibers 132 could also be PVC (polyvinyl chloride), polystyrene (PS), polyethylene or rayon fibers, which the invention is not limited to. In addition, the percentage by weight of the impurity-absorbing particles 134 in the whole structure is, for example, 5%-30% to obtain a better impurity-absorbing capability and a stronger structure strength. In other embodiments, the percentage by weight of the water-absorbing particles 134 in the whole structure could be other appropriate values depending on the requirement.

As shown in FIG. 3, it is allowed to mix a plurality of core-sheath fibers 138 in the non-woven fibers 132 (one core-sheath fiber 138 is shown). Each of the core-sheath fibers 138 includes a core layer 138a and a sheath layer 138b, and the sheath layer 138b wraps the core layer 138a. A part of the water-absorbing particles 134 are combined with the sheath layer 138b to form a structure with the non-woven fibers 132 and the core-sheath fibers 138. In the embodiment, the materials of the core layer 138a and the sheath layer 138b are, for example, plastic, the melting point of the non-woven fibers 132 is higher than the melting point of the sheath layer 138b and the melting point of the core layer 138a is higher than the melting point of the sheath layer 138b. During the process of combining the non-woven fibers 132, the hot-melt powder particles 136, the impurity-absorbing particles 134 and the core-sheath fiber 138 together, the heating temperature range between the melting point of the non-woven fibers 132 and the melting point of the hot-melt powder particles 136 and between the melting point of the core layer 138a and the melting point of the sheath layer 138b so as to make the sheath layer 138b heated and fused to combine with the impurity-absorbing particles 134. At the time, due to the core layer 138a with a higher melting point, the core layer 138a is not melted so as to be able support the whole structure. Taking an example, the material of the core layer 138a could be polypropylene (PP) with an approximate melting point of 180° C., while the material of the sheath layer 138b could be polyethylene (PE) with an approximate melting point of 127° C.

Referring to FIG. 1, the guiding tank 110 of the embodiment has a plurality of bafflers 112 therein so as to form a zigzag channel in the guiding tank 110, and the first water-absorbing material 120, the porous filter material 130 and the second water-absorbing material 140 fill into the zigzag channel. By using the bafflers 112, the moving path of the hydrogen V1 in the first water-absorbing material 120, the porous filter material 130, and the second water-absorbing material 140 is increased to improve the filtering effect.

In the embodiment, the material of the second water-absorbing material 140 is, for example, cotton or other suitable water-absorbing materials, which the invention is not limited to. In addition, more water-absorbing materials could be disposed in the guiding tank 110 to improve the filtering effect. In following, some examples including figures are explained.

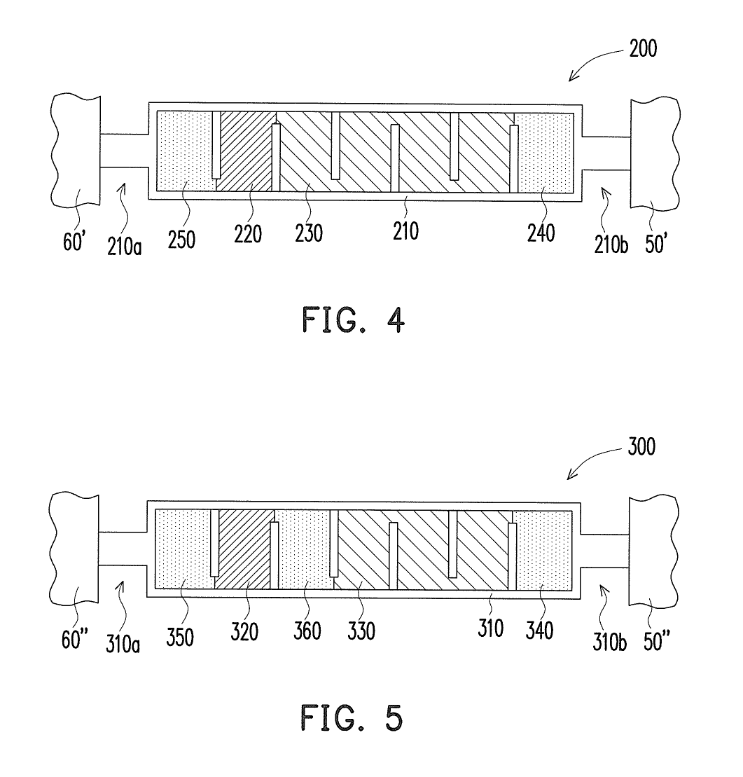

FIG. 4 is a schematic diagram of a hydrogen-purifying device according to another embodiment of the invention. Referring to FIG. 4, the hydrogen-purifying device 200 of the embodiment includes a guiding tank 210, a first water-absorbing material 220, a porous filter material 230, and a second water-absorbing material 240. The first end 210a of the guiding tank 210 is connected to a hydrogen-purifying device 60′, the second end 210b of the guiding tank 210 is connected to a fuel cell 50′. The layout and the function of the guiding tank 210, the first water-absorbing material 220, the porous filter materials 230, and the second water-absorbing material 240 are similar to the layout and the function of the guiding tank 110, the first water-absorbing material 120, the porous filter materials 130, and the second water-absorbing material 140 in FIG. 1, which is omitted to describe. The hydrogen-purifying device 200 further includes a third water-absorbing material 250 disposed in the guiding tank 210 and between the first end 210a and the first water-absorbing material 220 of the guiding tank 210 to further improve the filtering effect. The material of the third water-absorbing material 250 is, for example, cotton or other suitable water-absorbing materials, which the invention is not limited to.

FIG. 5 is a schematic diagram of a hydrogen-purifying device according to yet another embodiment of the invention. Referring to FIG. 5, the hydrogen-purifying device 300 of the embodiment includes a guiding tank 310, a first water-absorbing material 320, a porous filter material 330, a second water-absorbing material 340, and a third water-absorbing material 350. The first end 310a of the guiding tank 310 is connected to a hydrogen-purifying device 60″, the second end 310b of the guiding tank 310 is connected to a fuel cell 50″. The layout and the function of the guiding tank 310, the first water-absorbing material 320, the porous filter materials 330, the second water-absorbing material 340 and the third water-absorbing material 350 are similar to the layout and the function of the guiding tank 210, the first water-absorbing material 220, the porous filter materials 230, the second water-absorbing material 240 and the third water-absorbing material 250 in FIG. 4, which is omitted to describe. The hydrogen-purifying device 300 further includes a fourth water-absorbing material 360 disposed in the guiding tank 310 and between the first water-absorbing material 320 and the porous filter material 330 to further improve the filtering effect. The material of the fourth water-absorbing material 360 is, for example, cotton or other suitable water-absorbing materials, which the invention is not limited to.

In summary, in the embodiments of the invention, the hydrogen-purifying device uses the porous filter material to filter out the impurities mixed with the hydrogen to avoid the impurities accompanying the hydrogen to arrive at the fuel cell and result in a negative effect on the fuel cell. In addition, prior to the hydrogen passes through the porous filter material, the hydrogen passes through the first water-absorbing material to remove at least a part of the moisture mixed with the hydrogen, which reduces the destruction on the porous filter material by the acid substance in the moisture to ensure the good filtering effect of the porous filter material. Moreover, after the hydrogen passes through the porous filter material, the hydrogen further passes through the second water-absorbing material to further remove the rest moisture and avoid excessive moisture entering the fuel cell to affect the normal operation. In addition, by disposing a plurality of bafflers in the guiding tank to form a zigzag channel, the moving path of the hydrogen in the guiding tank is increased to improve the filtering effect.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A hydrogen-purifying device, adapted for a fuel cell and comprising:
a guiding tank, having a first end and a second end opposite to the first end, wherein the first end is connected to a hydrogen-generating device, the second end is connected to the fuel cell, and the hydrogen-generating device generates a hydrogen, a moisture mixed with the hydrogen, and an impurity mixed with the hydrogen;
a first water-absorbing material, disposed in the guiding tank, wherein the hydrogen passes through the first water-absorbing material to remove a part of the moisture;
a porous filter material, disposed in the guiding tank and between the first water-absorbing material and the second end, wherein after the hydrogen passes through the first water-absorbing material, the hydrogen passes through the porous filter material to remove the impurity mixed with the hydrogen; and
a second water-absorbing material, disposed in the guiding tank and between the porous filter material and the second end, wherein after the hydrogen passes through the porous filter material, the hydrogen passes through the second water-absorbing material to remove another part of the moisture and arrives at the fuel cell.

2. The hydrogen-purifying device as claimed in claim 1, wherein the impurity comprises ammonia (NH₃), hydrogen sulfide (H₂S) or carbon monoxide (CO).

3. The hydrogen-purifying device as claimed in claim 1, wherein the first water-absorbing material comprises a non-woven fabric structure.

4. The hydrogen-purifying device as claimed in claim 3, wherein the non-woven fabric structure comprises:
a plurality of non-woven fibers; and
a plurality of water-absorbing particles, wherein at least a part of the water-absorbing particles are combined with the non-woven fibers.

5. The hydrogen-purifying device as claimed in claim 4, wherein the non-woven fabric structure further comprises a plurality of hot-melt powder particles, a melting point of the non-woven fibers is higher than a melting point of the hot-melt powder particles, the hot-melt powder particles are combined with the non-woven fibers, and at least a part of the water-absorbing particles are combined with the hot-melt powder particles.

6. The hydrogen-purifying device as claimed in claim 4, wherein the non-woven fabric structure further comprises a plurality of core-sheath fibers and each of the core-sheath fibers comprises:
a core layer; and
a sheath layer, wrapping the core layer, wherein the melting point of the non-woven fibers and a melting point of the core layer are higher than a melting point of the sheath layer, and a part of the water-absorbing particles are combined with the sheath layer.

7. The hydrogen-purifying device as claimed in claim 4, wherein a material of the water-absorbing particles comprises calcium chloride (CaCl₂), calcium oxide (CaO), silica gel, iron powder, sodium chloride (NaCl), zeolite, activated carbon, phosphorus pentoxide, poly sodium acrylate, cane fibers, sodium borohydride (NaBH₄), porous acidic water-absorbing material, psyllium flour, acidic polymer, alkaline polymer or cobalt chloride (CoCl₂).

8. The hydrogen-purifying device as claimed in claim 1, wherein the porous filter material comprises a non-woven fabric structure.

9. The hydrogen-purifying device as claimed in claim 8, wherein the non-woven fabric structure comprises:
a plurality of non-woven fibers; and
a plurality of impurity-absorbing particles, wherein at least a part of the impurity-absorbing particles are combined with the non-woven fibers.

10. The hydrogen-purifying device as claimed in claim 9, wherein the non-woven fabric structure further comprises a plurality of hot-melt powder particles, the hot-melt powder particles are combined with the non-woven fibers, and at least a part of the impurity-absorbing particles are combined with the hot-melt powder particles.

11. The hydrogen-purifying device as claimed in claim 9, wherein the non-woven fabric structure further comprises a plurality of core-sheath fibers and each of the core-sheath fibers comprises:
a core layer; and
a sheath layer, wrapping the core layer, wherein a melting point of the non-woven fibers and a melting point of the core layer are higher than a melting point of the sheath layer, and a part of the impurity-absorbing particles are combined with the sheath layer.

12. The hydrogen-purifying device as claimed in claim 9, wherein the material of the impurity-absorbing particles comprises activated carbon, zeolite, solid acid, acidic polymer or alkaline polymer.

13. The hydrogen-purifying device as claimed in claim 1, wherein a material of the second water-absorbing material comprises cotton.

14. The hydrogen-purifying device as claimed in claim 1, further comprising a third water-absorbing material disposed in the guiding tank and located between the first end and the first water-absorbing material.

15. The hydrogen-purifying device as claimed in claim 14, wherein a material of the third water-absorbing material comprises cotton.

16. The hydrogen-purifying device as claimed in claim 1, wherein the guiding tank has a plurality of bafflers so as to form a zigzag channel in the guiding tank, and the first water-absorbing material, the porous filter material, and the second water-absorbing material fill into the zigzag channel.
